(19) United States
(12) Patent Application Publication
(10) Pub. No.: US 2004/0233373 A1
(43) Pub. Date: Nov. 25, 2004

(54) Method of assembling substrates, apparatus for assembling substrates, method of dropping liquid material, and apparatus for dropping liquid material

(75) Inventor: Shinichi Ogimoto, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/704,723

(22) Filed: Nov. 10, 2003

(30) Foreign Application Priority Data
Nov. 11, 2002 (JP) 2002-327092

(51) Int. Cl. G02F 1/1339

(52) U.S. Cl. 349/153

(57) ABSTRACT

The present invention comprises an application step of applying a sealing agent 7 onto one of two substrates 3 and 4 in the form of a frame having corner portions, a dropping step of dropping a liquid material onto one of the two substrates with a predetermined arrangement pattern and dropping the liquid material only to corner portions of a peripheral portion deviating from the arrangement pattern in an area surrounded by the sealing agent, and a bonding step of bonding the two substrates to each other in a reduced pressure atmosphere.

### CROSS-REFERENCE TO RELATED APPLICATIONS

This application is based upon and claims the benefit of priority from the prior Japanese Patent Application No. 2002-327092, filed Nov. 11, 2002, the entire contents of which are incorporated herein by reference.

### BACKGROUND OF THE INVENTION

1. Field of the Invention

The present invention relates to a method of assembling substrates, an apparatus for assembling substrates, a method of dropping a liquid material on the substrates, and an apparatus for dropping a liquid material on the substrate.

2. Description of the Related Art

As well known, when manufacturing a liquid crystal display panel, two transparent substrates are bonded to each other with an interval of several μm by using a sealing agent, and these substrates are assembled with a liquid crystal which is a liquid material being interposed therebetween.

In a conventional method, in order to assemble two substrates, there are carried out a step of applying a sealing agent consisting of a visco-elastic material onto one substrate, a step of dropping a predetermined quantity of a liquid crystal on one or the other substrate, and a step of bonding the two substrates to each other in a reduced pressure atmosphere by using the above-described sealing agent. Such a technique is disclosed in Jpn. Pat. Appln. KOKAI Publication No. 5-281562.

A differential pressure between an internal pressure and an external pressure is in the atmospheric air applied to a liquid crystal display panel bonded in the reduced pressure atmosphere. If the liquid crystal is evenly applied between a pair of substrates, the liquid crystal causes the substrates to demonstrate a substantially even pressure resistance and prevents the substrates from bending, thereby avoiding the uneven gap between the substrates.

Meanwhile, when the sealing agent is applied in the form of a rectangular frame to one substrate, the liquid crystal is dropped in a predetermined arrangement pattern, e.g., a matrix form in an area surrounding by the sealing agent and then the two substrates are bonded to each other in the reduced pressure atmosphere, the liquid crystal may be hard to be evenly distributed in the above-described area between the substrates in some cases. In particular, the liquid crystal is hard to spread in a peripheral portion deviating from the predetermined arrangement pattern in the area surrounded by the sealing agent, and the liquid crystal is more difficult to spread at four corner portions of the peripheral portion.

A quantity of the liquid crystal which spreads to the peripheral portion distanced from the predetermined arrangement pattern in the area surrounded by the sealing agent may be smaller than that in any other portion in this manner. Then, the peripheral portion distanced from the predetermined arrangement pattern in the area surrounded by the sealing agent on the substrate, i.e., a position where the quantity of the applied liquid crystal is insufficient, is more compressed than any other portion by a differential pressure between an internal pressure and an external pressure of the bonded substrate when the bonded substrates are returned in the atmospheric air. The bending degree of the substrate increases. Therefore, a gap between the pair of substrates at the peripheral portion may be smaller than a gap at any other portion.

In particular, since the substrate tends to be thinned or increased in size in recent years, the liquid crystal is hard to spread to the peripheral portion distanced from the predetermined arrangement pattern in the area surrounded by the sealing agent, and a thin substrates is apt to largely bend at the peripheral portion.

Further, when the peripheral portion of the substrates distanced from the predetermined arrangement pattern in the area surrounded by the sealing agent is greatly compressed and deformed as compared with any other portions, a restoring force of the substrates acts on the bent position. As a result, a tensile force acts on the sealing agent compressed at the time of bonding, and hence a crack or a fracture is generated to the sealing agent due to the tensile force.

It is an object of the present invention to provide a method of assembling substrates, an apparatus for assembling substrates, a method of dropping a liquid material and an apparatus for dropping a liquid material which can cause a liquid material to be evenly distributed between a pair of substrates to be bonded on each other.

### BRIEF SUMMARY OF THE INVENTION

According to the present invention, there is provided a method of assembling substrates, comprising:

an applying step of applying a sealing agent to one of two substrates in the form of a frame having corner portions;

a dropping step of dropping a liquid material which is broken into droplets to one of the two substrates with a predetermined arrangement pattern, and dropping the liquid material only to corner portions of a peripheral portion deviating from the arrangement pattern in an area surrounded by the sealing agent; and

a bonding step of bonding the two substrates in a reduced pressure atmosphere.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view illustrating an outline of an assembling apparatus according to a first embodiment of the present invention;

FIG. 2A is a schematic view of a sealing agent applying device, and FIG. 2B is a plane view of a substrate onto which a sealing agent is applied;

FIG. 3 is a schematic view of a liquid crystal dropping device;

FIG. 4 is an enlarged cross-sectional view showing a dropping nozzle of the dropping device;

FIG. 5A is a schematic view of a bonding device, and FIG. 5B is an enlarged cross-sectional view showing a part of two substrates bonded on each other;

FIG. 6 is an explanatory view showing a dropping state of first droplets and second droplets applied onto a first substrate;

FIG. 7 is an explanatory view of the first droplets and the second droplets which are dropped on the first substrates, showing a second embodiment according to the present invention;

FIGS. 8a to 8C are explanatory views of the second droplets which are dropped on four corners of a peripheral portion deviating from an arrangement pattern, showing a third embodiment of the present invention;

FIG. 9 is an explanatory view of the first droplets and the second droplets dropped on the first substrate, showing a fourth embodiment according to the present invention; and

FIG. 10 is an explanatory view showing a dropping state of the first droplets and the second droplets, showing the second embodiment according to the present invention.

### DETAILED DESCRIPTION OF THE INVENTION

Embodiments according to the present invention will now be described hereinafter with reference to the accompanying drawings.

FIG. 1 shows a schematic structure of a substrate assembling apparatus 1 according to a first embodiment of the present invention. This assembling apparatus 1 includes a sealing agent applying device 2. To this applying device 2 is supplied one of a first substrate 3 and a second substrate 4 constituting a liquid crystal display panel, e.g., the first substrate 3.

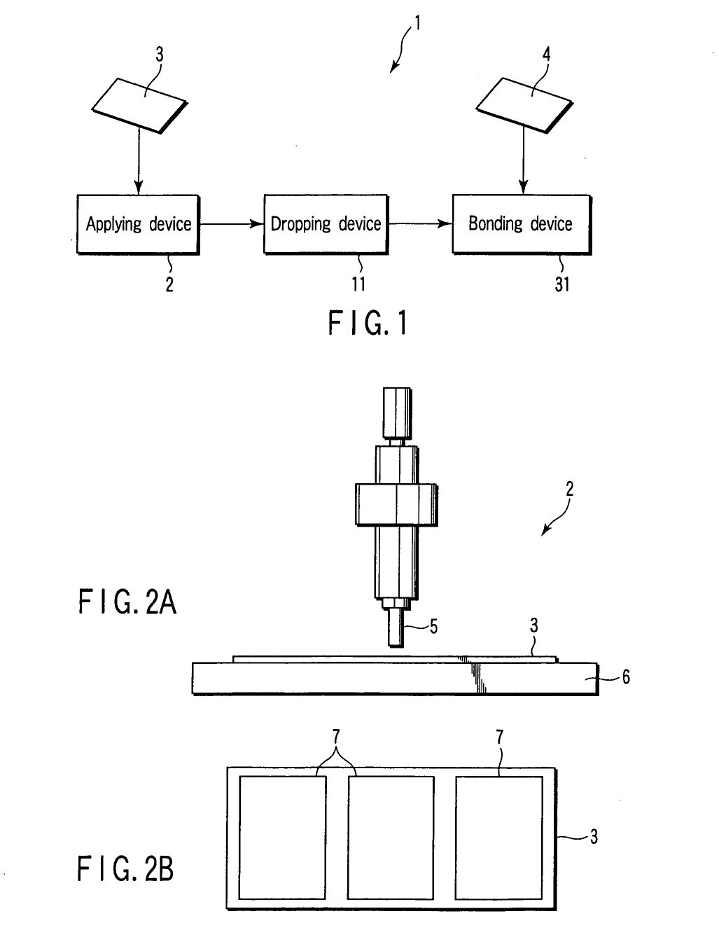

As shown in FIG. 2A, the applying device 2 includes an application nozzle 5 which is driven in directions X, Y and Z and a first table 6 on which the first substrate 3 is supplied and mounted. When the first substrate 3 is supplied onto the first table 6, the application nozzle 5 moves down in the direction Z and causes its end to be opposed to an upper surface (inner surface) of the first substrate 3 with a predetermined gap. Thereafter, this nozzle is driven in the directions X and Y based on a preset coordinate. As a result, as shown in FIG. 2b, a sealing agent is applied in the form of a plurality of frames, i.e., three rectangular frames in this embodiment, onto the first substrate 3.

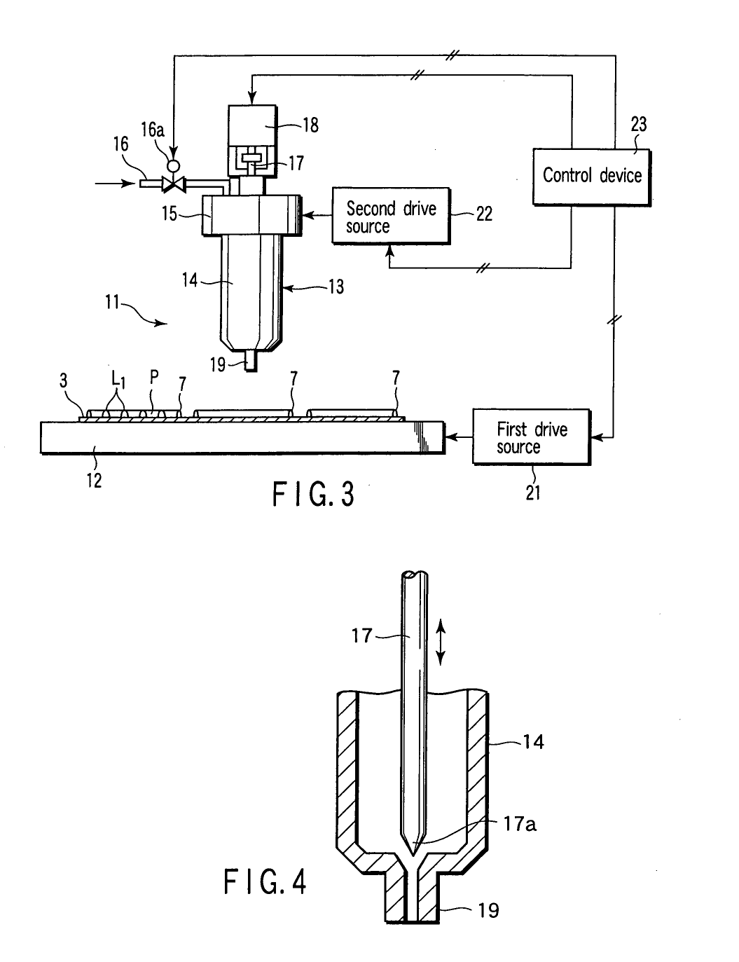

The first substrate 3 having the sealing agent 7 applied thereon is carried to a dropping device 11. As shown in FIG. 3, this dropping device 11 has a second table 12 on which the first substrate 3 is mounted and a dropping nozzle 13 which drops and supplies a liquid crystal as a liquid material to the first substrate 3 mounted on the second table 12 with a predetermined pattern.

The dropping nozzle 13 has a container 14 which has an opened upper end and accommodates the liquid crystal therein. The upper end opening of this container 14 is closed by a cover body 15. To this cover body 15 is connected a pressurizing tube 16 which supplies a gas which applies a pressure to the liquid crystal in the container 14. An opening/closing valve 16a which intermittently supplies the pressurizing gas into the container 14 is provided to the pressurizing tube 16.

An adjustment valve 17 is slidably provided to the cover body 15. This adjustment valve 17 is driven in the upper and lower directions by an actuator 18 provided to the cover body 15.

As shown in FIG. 4, a nozzle outlet body 19 is provided at the lower end of the container 14. An opening of the nozzle outlet body 19 is controlled by a valve body 17a formed at the end portion of the adjustment valve 17 which is driven in the upper and lower directions. When an opening of the nozzle outlet body 19 is controlled by using the valve body 17a, a size of each droplet of the liquid crystal dropped from this nozzle outlet body 19 onto the first substrate 3, i.e., a droplet quantity can be adjusted.

The second table 12 is driven in directions X and Y by a first drive source 21, and the container 14 is driven in at least the direction Z of the directions X, Y and Z by a second drive source 22. That is, the second table 12 and the dropping nozzle 13 are relatively driven in the horizontal direction and the upper and lower directions by the first and second drive sources 21 and 22.

The control valve 16a, the actuator 18, the first drive source 21 and the second drive source 22 are controlled by a control device 23. That is, when the first substrate 3 having the sealing agent 7 applied thereonto is supplied and mounted on the second table 12, the dropping nozzle 13 is driven in the downward direction to a predetermined height in the direction Z by the second drive source 22. At the same time, the adjustment valve 17 is controlled by the actuator 18, and an opening of the nozzle outlet body 19 is set.

Then, the second table 12 is driven by the first drive source 21 in the directions X and Y based on a coordinate preset in the control device 23. When the nozzle outlet body 19 is positioned at a predetermined coordinate, the opening/closing valve 16a is opened, and the pressurizing gas is supplied into the container 14.

As a result, the liquid crystal is dropped and supplied as a plurality of first droplets L₁ in an area R having a rectangular frame shape surrounded by the sealing agent 7 on the first substrate 3 with a predetermined arrangement pattern P. In this embodiment, the first droplets L₁ are dropped in the area R having the rectangular frame shape surrounded by the sealing agent 7 with the arrangement pattern P in a matrix form having even intervals with respect to a row direction and a column direction.

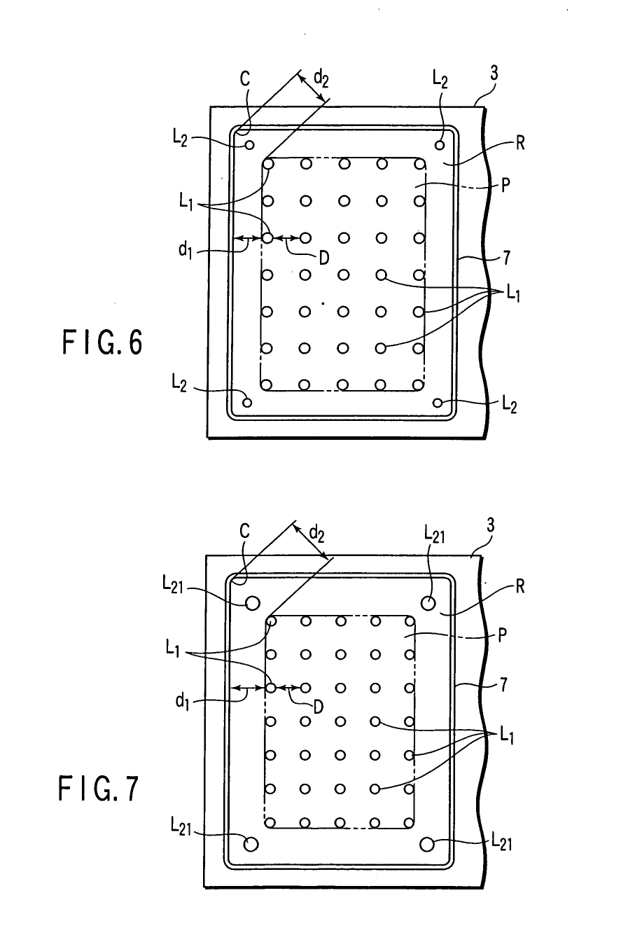

As shown in FIG. 6, when the liquid crystal is dropped and supplied as the first droplets L₁ in the area R surrounded by the sealing agent 7 with the arrangement pattern P in a predetermined matrix form, the dropping nozzle 13 is sequentially positioned at four corner portions of a peripheral portion deviating from this arrangement pattern P, and second droplets L₂ are supplied and dropped one by one to the four corner portions. It is to be noted that the above-described arrangement pattern P in the predetermined matrix form has a similar figure smaller than the area R having a rectangular frame shape surrounded by the sealing agent 7.

A size of the second droplet L₂ is set smaller than that of the first droplet L₁. That is, when dropping the second droplets L₂ to the four corner portions of the area R surrounded by the sealing agent 7 by using the dropping nozzle 13, the actuator 18 is driven and controlled by the control device 23 in such a manner that an opening of the nozzle outlet body 19 obtained by the adjustment valve 17 becomes smaller than that when dropping the first droplets L₁, i.e., a droplet quantity becomes small. As a result, when the two substrates 3 and 4 are bonded to each other in the reduced pressure atmosphere as will be described later, the liquid crystal can be substantially evenly dispersed between the substrates 3 and 4.

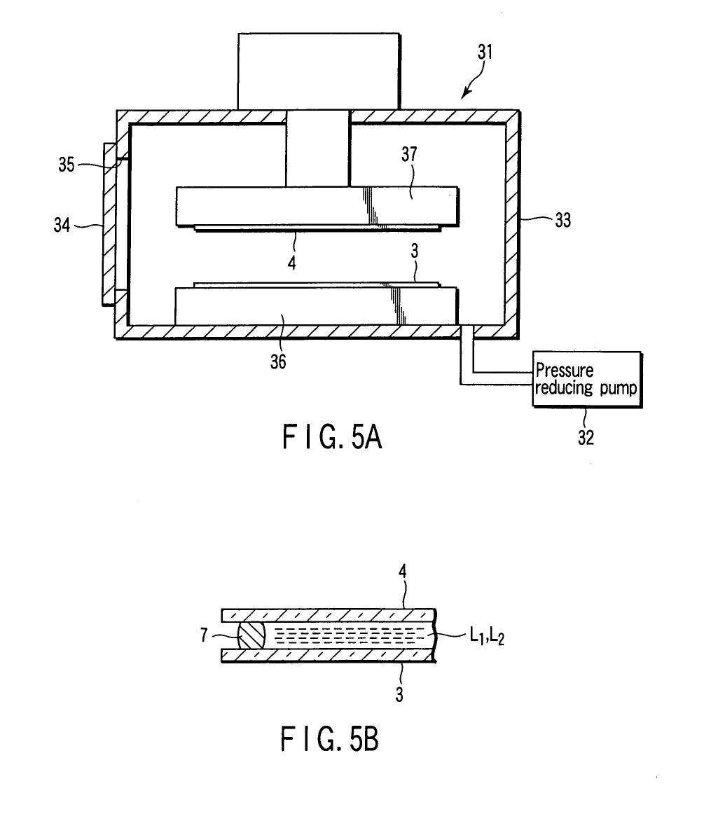

The first substrate 3 having the sealing agent 7 applied thereonto and the first and second droplets L₁ and L₂ dropped thereon and the second substrate 4 are bonded to each other by a bonding device 31. As shown in FIG. 5A, this bonding device 31 has a chamber 33 in which a pressure is reduced by a pressure reducing pump 32, and an port opening 35 which is opened/closed by a shutter 34 is formed on one side of this chamber 33.

A table 36 which is driven in directions X, Y and θ is provided in the chamber 33, and a chuck 37 which is driven in a direction Z is provided above this table 36. The first substrate 3 is held on the table 36 with its inner surface facing up, and the second substrate 4 is held on the chuck 37 with its inner surface facing down when its outer surface (upper surface) is sucked.

When the first substrate 3 and the second substrate 4 are supplied into the chamber 33 of the bonding device 31, the port opening 35 of this chamber 33 is air-tightly closed by the shutter 34, and a pressure in this chamber 33 is reduced by the pressure reducing pump 32 until a predetermined pressure is obtained.

Subsequently, after the first substrate 3 is positioned in the directions X, Y and θ with respect to the second substrate 4, the second substrate 4 is moved down and pressed against the first substrate 3 with a predetermined pressure, thereby bonding the two substrates. Thereafter, the inside of the chamber 33 is returned to the atmospheric pressure. As a result, a pressurizing force caused due to a differential pressure between an internal pressure and an external pressure acts on the two substrates 3 and 4 bonded through the sealing agent 7, the first substrate 3 and the second substrate 4 compress the sealing agent 7, and a substrate gap of the μm order defined by a non-illustrated spacer arranged between the substrates 3 and 4 is formed. Then, the sealing agent 7 is hardened by irradiation of ultraviolet rays or heating, and the liquid crystal dropped and supplied as the first droplets L₁ and the second droplets L₂ is sealed between the substrates 3 and 4 as shown in FIG. 5B.

In the area R surrounded by the sealing agent 7 on the first substrate 3, the first droplets L₁ are dropped with the arrangement pattern P in the matrix form, and the second droplets L₂ are dropped one by one to the four corner portions of the peripheral portion deviating from the arrangement pattern P.

If the liquid crystal as the first droplets L1 are just dropped and supplied in the area R surrounded by the sealing agent 7 with the arrangement pattern P in the matrix form, the liquid crystal is hard to spread to the peripheral portion deviating from the arrangement pattern P of the first droplets L₁ in the area R as compared with the position of the arrangement pattern P of the first droplets L₁ when the two substrates 3 and 4 are bonded to each other. The liquid crystal is further hard to spread to the four corners of the area R in particular in the peripheral portion.

One reason is that a distance d₁ from the first droplet L₁ positioned at an outermost peripheral portion of the arrangement pattern P to an inner peripheral edge of the area R surrounded by the sealing agent 7 may be greater than ½ of a distance D between the adjacent first droplets L₁ in some cases as shown in FIG. 6 when the first droplets L₁ are dropped with the arrangement pattern P in the matrix form. Furthermore, a distance d₂ from the first droplet L₁ positioned at one of the four corners of the arrangement pattern P to a corner C of the sealing agent 7 having the rectangular frame shape becomes larger than d₁. That is, D/2<d₁<d₂ is achieved.

Therefore, when the two substrates 3 and 4 are bonded to each other in the reduced pressure atmosphere, it can be considered that it is most difficult for the liquid crystal to reach the corner C of the sealing agent 7 having the rectangular frame shape corresponding to a maximum distance from the first droplets L₁ forming the arrangement pattern P in the area R surrounded by the sealing agent 7.

Thus, in the embodiment according to the present invention, not only the first droplets L₁ are dropped and supplied in the matrix form as the predetermined arrangement pattern P in the area R surrounded by the is sealing agent 7, but also the second droplets L₂ are dropped onto the four corner portions in the peripheral portion deviating from this arrangement pattern P.

Therefore, when the two substrates 3 and 4 are bonded to each other, since the second droplets L₂ dropped and supplied to the four corner portions assuredly flow to the corners C at the four corner portions of the area R surrounded by the sealing agent 7, the liquid crystal can be substantially evenly distributed between the substrates 3 and 4.

A size of the second droplet L₂ which is dropped and supplied to the four corner portions is smaller than that of the first droplet L₁ which is dropped and supplied with the arrangement pattern P in the matrix form. Therefore, it is possible to prevent the second droplets L₂ from swifly flowing toward the four corner portions of the area R surrounded by the sealing agent 7 or prevent a supply quantity of the liquid crystal per unit area at the four corner portions from being larger than that at any other portion when the two substrates 3 and 4 are bonded to each other.

As a result, since it is possible to prevent the sealing agent 7 at the corners C of the four corner portions of the area R from being broken due to a pressure of the second droplets L₂ when the two substrates 3 and 4 are bonded to each other, the two substrates 3 and 4 can be assuredly bonded without damaging the sealing agent 7.

If the liquid crystal can be substantially evenly distributed between the two substrates 3 and 4 in this manner, the peripheral portion, especially the four corner portions deviating from the pattern P in the area R surrounded by the sealing agent 7 of the substrates 3 and 4 can be prevented from largely bending as compared with any other portion even through the substrates 3 and 4 undergo the differential pressure between the internal pressure and the external pressure after bonding the substrates 3 and 4 to each other.

Further, since the substrates 3 and 4 can be prevented from bending, it is possible to avoid a damage to the sealing agent 7 which occurs when the sealing agent 7 receives the tensile force due to restoring the bent substrates 3 and 4 like the prior art.

It is to be noted that an optimum quantity of the second droplets L₂ varies depending on a quantity of the first droplets L₁, the arrangement pattern P, the distances D, d₁, d₂ and others, but it can be obtained from experiments and the like.

FIG. 7 shows a second embodiment according to the present invention. In this embodiment, a size of each droplet L₂₁ provided at the four corners in the peripheral portion away from the arrangement pattern P in the area R surrounded by the sealing agent 7 is larger than that of each droplet L₁ forming the arrangement pattern P.

That is, when setting the arrangement pattern P with respect to the area R, a ratio of a superficial content of the arrangement pattern P relative to a superficial content of the area R may be changed in some cases. In FIG. 7, a ratio of the superficial content of the arrangement pattern P relative to the superficial content of the area R is smaller than the ratio shown in FIG. 6. When the area ratio is changed in this manner, the distance d₂ from the first droplet L₁ positioned at one of the four corner portions of the arrangement pattern P to the corner C of the sealing agent 7 naturally varies.

When a difference in size between the superficial content of the area R and the superficial content of the arrangement pattern P is small, since the distance d₂ is also small, making the size of the second droplet L₂ provided at each of the four corner portions of the peripheral portion deviating from the arrangement pattern P smaller than each droplet L₁ forming the arrangement pattern P can cause the liquid crystal to be evenly distributed at the corners C.

However, when a difference between the superficial content of the area R and the superficial content of the arrangement pattern P is large, the distance d₂ is large. Therefore, when the distance d₂ is not less than a predetermined value, the size of the second droplet L₂₁ provided at each of the four corner portions of the peripheral portion deviating from the arrangement pattern P is set larger than that of the first droplet L₁ forming the arrangement pattern P as shown in FIG. 7. As a result, the liquid crystal can be evenly distributed to the corners C.

It is to be noted that the size of the second droplet L₂₁ should be substantially equal to that of the first droplet L₁ depending on the distance d₂ in some cases.

Furthermore, although the description has been given as to the case that the dropping positions of the plurality of second droplets L₂₂ to L₂₄ which are dropped at the four corner portions of the peripheral portion deviating from the predetermined pattern P in the area R are set symmetrically with respect to the straight line 41 or set on the straight line 41, the present invention is not restricted to such positions, and these positions may be staggered with the straight line 41 at the center, for example.

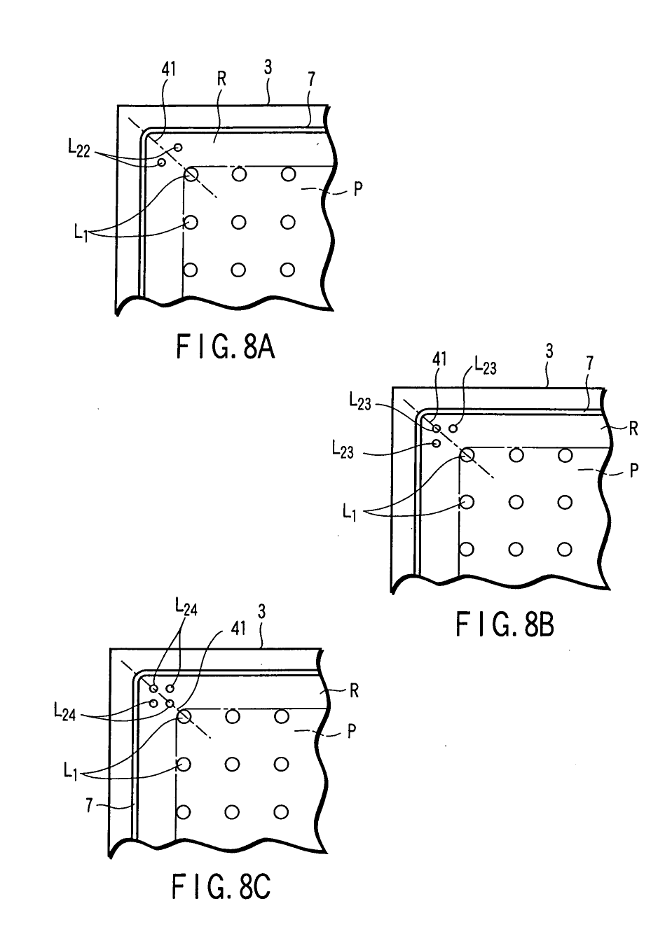

FIGS. 8A to 8C show a third embodiment according to the present invention. In the above-described embodiment, one droplet L₂ or L₂₁ is provided at each of the four corner portions of the peripheral portion deviating from the pattern P in the area R surrounded by the sealing agent 7. However, in this embodiment, a plurality of second droplets are provided.

That is, in FIG. 8A, two second droplets L₂₂ are arranged symmetrically with respect to a straight line 41 connecting the first droplet L₁ positioned at one of the four corner portions (corner portion) of the arrangement pattern P and the corner C. In FIG. 8B, one second droplet L₂₃ is provided on the straight line 41 in addition to the two second droplets L₂₃ arranged as shown in FIG. 8A, and hence the three droplets are provided in total. In FIG. 8C, two second droplets L₂₄ are provided with the straight line 41 therebetween and two second droplets L₂₄ are provided on the straight line 41, and hence the four droplets are provided in total.

Each of the plurality of divided second droplets L₂₂ to L₂₄ is set smaller than the first droplet L₁ forming the arrangement pattern P. In this embodiment, when the two second droplets L₂₂ are provided, a total droplet quantity of the two droplets L₂₂ is set substantially equal to a quantity of one second droplet L₂ or L₂₁ shown in FIG. 6 or 7. In case of the three droplets, a total quantity of the three second droplets L₂₃ is set substantially equal to a quantity of one second droplet L₂ or L₂₁. Likewise, in case of the four droplets, a total quantity of the four second droplets L₂₄ is set substantially equal to a quantity of one second droplet L₂ or L₂₁. That is, a relationship in size of the second droplets L₂₂ to L₂₄ is L₂₂>L₂₃>L₂₄.

In this manner, the plurality of second droplets L₂₂ to L₂₄ each of which is divided to have a size corresponding to a fraction of the second droplet L₂ or L₂₁ are provided at each of the four corner portions of the peripheral portion deviating from the pattern P in the area R surrounded by the sealing agent 7.

Therefore, when bonding the first substrate 3 and the second substrate 4 to each other, since a degree that the second droplets L₂₂ to L₂₄ are crushed is smaller than that in case of the second droplet L₂ or L₂₁, a range (superficial content) in which one of the crushed second droplets L₂₂ to L₂₄ spreads is also small. As a result, a range in which the crushed second droplets L₂₂ to L₂₄ spread on the first substrate 3 can be easily estimated, the plurality of the second droplets L₂₂ to L₂₄ can be provided at the four corner portions of the peripheral portion deviating from the arrangement pattern P in such a manner that they are evenly distributed to the four corner portions of the area R without damaging the sealing agent 7.

It is to be noted that the description has been given as to the case the second droplets L₂₂ to L₂₄ are divided into two to four pieces in this embodiment, the divided number is not restricted thereto, and it may be five or above.

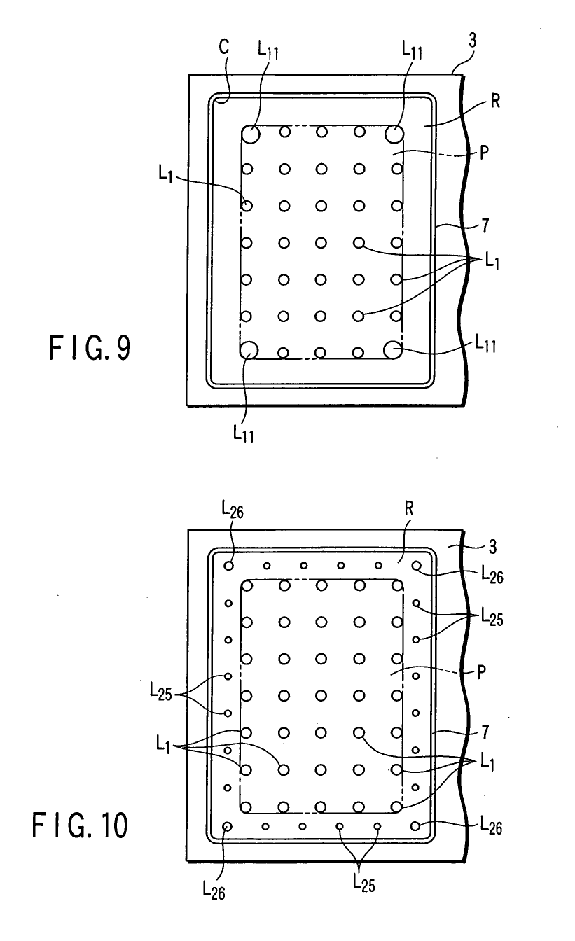

FIG. 9 shows a fourth embodiment according to the present invention. In this embodiment, the second droplets are not provided at the four corner portions of the peripheral portion deviating from the arrangement pattern P in the area R surrounded by the sealing agent 7, and a size of the first droplet L₁₁ positioned at each of the four corner portions of the arrangement pattern P is set larger than that of any other first droplet L₁ in this arrangement pattern P.

When a size of the first droplet L₁₁ positioned at each of the four corner portions of the arrangement pattern P is set larger than that of any other first droplet L₁, the droplets L₁₁ at the four corner portions flow toward the corners C of the sealing agent 7 when bonding the substrates 3 and 4 to each other, and hence it is possible to make up for a deficiency of the liquid crystal at the corners C, thereby evenly distributing the liquid crystal between the substrates 3 and 4.

FIG. 10 shows a fifth embodiment according to the present invention. In the first embodiment, the second droplets L₂ are dropped one by one only to the four corner portions in the area R surrounded by the sealing agent 7 on the first substrate 3. However, in this embodiment, as shown in FIG. 10, the second droplets are dropped in the circumferential direction at predetermined intervals to the peripheral portion deviating from the arrangement pattern P of the first droplets L₁ in the area R. Here, of the second droplets provided to the peripheral portion, the droplets except the four droplets positioned at the four corner portions are determined as L₂₅, and the four droplets are determined as L₂₆.

Sizes of the second droplets L₂₅ and L₂₆ are smaller than that of the first droplet L₁ forming the arrangement pattern P. Moreover, of the second droplets, the respective second droplets L₂₆ positioned at the four corner portions are set so as to be slightly larger than the other second droplets L₂₅. That is, the second droplets L₂₆ positioned at the four corner portions of the peripheral portion deviating from the arrangement pattern P in the area R are set larger than the other second droplets L₂₅ in this peripheral portion.

When the second droplets L₂₅ and L₂₆ are dropped and supplied over the entire length including the four corner portions of the peripheral portion deviating from the arrangement pattern P at predetermined intervals in the circumferential direction in this manner, the second droplets L₂₅ and L₂₆ assuredly flow over the entire area R surrounded by the sealing agent 7, and hence the liquid crystal can be substantially evenly dispersed in the entire area R.

The second droplets L₂₅ and L₂₆ provided in the peripheral portion in the area R are smaller than the first droplets L₁ provided at the portions other than the peripheral portion. Additionally, of the second droplets, the four second droplets L₂₆ positioned at the four corner portions are set larger than the other second droplets L₂₅ in the peripheral portion.

Therefore, when the two substrates 3 and 4 are bonded on each other in the reduced pressure atmosphere, the liquid crystal can be also distributed to the entire peripheral portion including the four corner portions in the area R surrounded by the sealing agent 7 in such a manner that a supply quantity of the liquid crystal per unit area becomes substantially equal.

In particular, the second droplets L₂₆ positioned at the four corner portions in the area R are larger than the second droplets L₂₅ positioned at any other parts in the peripheral portion. Therefore, the liquid crystal can be distributed to the four corner portions in the area R with substantially the same quantity as that in any other portion due to a difference in size between the second droplets L₂₅ and L₂₆.

Further, since the second droplets L₂₅ and L₂₆ positioned in the peripheral portion including the four corner portions are smaller than the first droplets L₁, the impetus of the second droplets L₂₅ and L₂₆ flowing toward the outer side can be reduced when bonding the substrates 3 and 4 on each other. Thus, it is possible to prevent the sealing agent 7 from being broken or deformed due to a pressure received by a flow of the second droplets L₂₆.

Incidentally, when there is a possibility that components in the sealing agent may be dissolved and the liquid crystal may be contaminated when the liquid crystal dropped onto the first substrate 3 comes into contact with the unhardened sealing agent in the assembling operation of the substrates such as described in connection with the foregoing embodiments, the assembling operation of the substrates may be carried out in the following manner.

That is, when the substrates are bonded in the reduced pressure atmosphere, the liquid crystal held between the two substrates 3 and 4 does not reach the sealing agent. Thereafter, when the bonded substrates 3 and 4 are placed in the atmospheric pressure, the liquid crystal gradually spreads between the substrates 3 and 4 by a pressurizing force applied thereto due to a differential pressure between an internal pressure and an external pressure, and the liquid crystal reaches the sealing agent with a timing after the sealing agent is hardened, thereby entering a state shown in FIG. 5B.

In such a case, the following operation should be performed.

A size of each of the second droplets L₂ and L₂₁ to L₂₄ in the examples shown in FIGS. 6 to 8C, a size of the first droplet L₁₁ in the example shown in FIG. 9 and a size of each of the second droplets L₂₅ and L₂₆ in the example shown in FIG. 10 are set to appropriate sizes with which the liquid crystal can be evenly distributed to the position close to the sealing agent in the area R even when the two substrates are bonded on each other and the liquid crystal is squashed and spread.

Such sizes of the droplets can be estimated based on the largeness of the distance d₂ from the first droplet L₁ positioned at each of the four corner portions of the arrangement pattern P to the corner C of the sealing agent. For example, when the distance d₂ is large, the sizes of the droplets become large as compared with the case that the distance d₂ is small.

By doing so, the liquid crystal can be evenly distributed to the position very close to the sealing agent without causing the liquid crystal to reach the sealing agent in the area R when bonding the substrates on each other in the reduced pressure atmosphere. As a result, since it is possible to avoid the contact of the liquid crystal dropped onto the first substrate 3 with the unhardened sealing agent, components included in the sealing agent can be prevented from being dissolved, which prevents contamination of the liquid crystal. Furthermore, a crack or a fracture of the sealing agent due to bending of the substrates such as described in connection with the prior art can be avoided as much as possible. Consequently, the reliability of quality of a liquid crystal display panel to be manufactured can be improved.

Incidentally, in this case, when the second droplets which are dropped at the four corner portions in the area R surrounded by the sealing agent are dropped in numbers like the third embodiment, a range in which the second liquid crystal is squashed and spread between the two substrates 3 and 4 can be preferably easily estimated as compared with the case that the second droplets are dropped at one position like the first and second embodiments.

Although the sealing agent 7 is applied onto the first substrate 3 and the first and second droplets are dropped and supplied on the first substrate 3 in each of the foregoing embodiments, the sealing agent 7 may be applied onto one of the first and second substrates 3 and 4 and the liquid crystal may be dropped and supplied onto the other one. That is, since a range corresponding to the area defined by the sealing agent applied onto one substrate can be set even in case of the other substrate on which the sealing agent is not applied, the liquid crystal can be dropped on the other substrate with a predetermined arrangement pattern.

The liquid material provided between the pair of substrates is not restricted to the liquid crystal, and any other liquid material can be adopted. In short, it is possible to adopt any liquid material which can be filled between the two substrates which are bonded with a predetermined gap therebetween by using the sealing agent.

One droplet which is dropped at one dropping position may be provided by one drop from the dropping nozzle or may be provided by drops for multiple times.

Applying the sealing agent in the form of a frame having corner portions can suffice. The rectangular frame shape is adopted in this embodiment, but any other polygonal frame shape can be used.

Either the sealing agent applying step or the liquid crystal dropping step can be performed first.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A method of assembling substrates, comprising:
an applying step of applying a sealing agent to one of two substrates in the form of a frame having corner portions;
a dropping step of dropping a liquid material to one of the two substrates in the form of droplets with a predetermined arrangement pattern, and dropping the liquid material only to corner portions in a peripheral portion deviating from the arrangement pattern in an area surrounded by the sealing agent; and
a bonding step of bonding the two substrates in a reduced pressure atmosphere.

2. The method of assembling substrates according to claim 1, wherein a droplet is dropped to each corner portion in the peripheral portion deviating from the arrangement pattern in the area in the dropping step, and a size of the droplet dropped to the corner portion is set smaller than a size of each droplet forming the arrangement pattern.

3. The method of assembling substrates according to claim 1, wherein a droplet is dropped to each corner portion in the peripheral portion deviating from the arrangement pattern in the area in the dropping step, and a size of the droplet dropped to the corner portion is set larger than a size of each droplet forming the arrangement pattern.

4. The method of assembling substrates according to claim 1, wherein a plurality of drops are dropped to each corner portion in the peripheral portion deviating from the arrangement pattern in the area in the dropping step, and a size of each droplet dropped to the corner portion is set smaller than a size of each droplet forming the arrangement pattern.

5. The method of assembling substrates according to claim 1, wherein the sealing agent is applied in a rectangular frame form.

6. A method of assembling substrates, comprising:
an applying step of applying a sealing agent to one of two substrates in the form of a frame having corner portions;
a dropping step of dropping the liquid material in the form of droplets to an area surrounded by the sealing agent and provided on one of the two substrates, after setting the droplets to be positioned at corner portions of the area to a size larger than the droplets to be positioned along the sealing agent; and
a bonding step of bonding the two substrates to each other in a reduced pressure atmosphere.

7. The method of assembling substrates according to claim 6, wherein the dropping step has:
a step of dropping the droplets in the area surrounded by the sealing agent with a predetermined arrangement pattern; and
a step of dropping the droplets in the peripheral portion deviating from the arrangement pattern in the area at predetermined intervals along the sealing agent, after setting the droplets to be positioned at corner portions of the area to a size larger than the droplets to be positioned in the peripheral portion.

8. The method of assembling substrates according to claim 6, wherein the droplets are dropped in the area surrounded by the sealing agent with a predetermined arrangement pattern in the dropping step, and a size of the droplet dropped to each corner portion in the arrangement pattern is set larger than a size of any other droplet.

9. The method of assembling substrates according to claim 6, wherein the sealing agent is applied in a rectangular frame form.

10. An apparatus for assembling substrates, comprising:
an applying device which applies a sealing agent onto one of two substrates in the form of a frame having corner portions;
a dropping device which has a dropping nozzle and drops a liquid material onto one of the two substrates in the form of droplets from the dropping nozzle;
a bonding device which bonds the two substrates on each other in a reduced pressure atmosphere; driving means for relatively driving the dropping nozzle and the substrate on which the droplets are dropped in the horizontal direction; and
a control device which drops the droplets on one of the two substrates with a predetermined arrangement pattern by controlling the driving by the driving means and dropping of the droplets from the dropping nozzle, and drops the droplets only to the corner portions of a peripheral portion deviating from the arrangement pattern in an area surrounded by the sealing agent.

11. The apparatus for assembling substrates according to claim 10, wherein the sealing agent is applied in a rectangular frame form.

12. An apparatus for assembling substrates, comprising:
an applying device which applies a sealing agent onto one of two substrates in the form of a frame having corner portions;
a dropping device which has a dropping nozzle and drops a liquid material onto one of the two substrates in the form of droplets from the dropping nozzle;
a bonding device which bonds the two substrates on each other in a reduced pressure atmosphere;
driving means for relatively driving the dropping nozzle and the substrate on which the droplets are dropped in the horizontal direction; and
a control device which controls the driving means and the dropping device which drops, thereby to drop the droplets from the nozzle to an area surrounded by the sealing agent and provided on one of the two substrates, after setting the droplets to be positioned at corner portions of the area to a size larger than the droplets to be positioned along the sealing agent.

13. The apparatus for assembling substrates according to claim 12, wherein the sealing agent is applied in a rectangular frame form.

14. A method of dropping a liquid material which drops a liquid material onto one of two substrates, comprising:
a step of dropping the liquid material in the form of droplets with a predetermined arrangement pattern in an area surrounded by applying a sealing agent onto one of the two substrates in the form of a frame having corner portions; and
a step of dropping the droplets only to corner portions in a peripheral portion deviating from the arrangement pattern in the area.

15. The method of dropping a liquid material according to claim 14, wherein the droplets are dropped to corner portions in a peripheral portion deviating from the arrangement pattern in the area, and a size of each droplet dropped to each corner portion is set smaller than a size of each droplet forming the arrangement pattern.

16. The method of dropping a liquid material according to claim 14, wherein the droplets are dropped to corner portions in a peripheral portion deviating from the arrangement pattern in the area, and a size of each droplet dropped to each corner portion is set larger than a size of each droplet forming the arrangement pattern.

17. The method of dropping a liquid material according to claim 14, wherein a plurality of droplets are dropped to each of corner portions in a peripheral portion deviating from the arrangement pattern in the area, and a size of each droplet dropped to the corner portion is set smaller than a size of each droplet forming the arrangement pattern.

18. The method of dropping a liquid material according to claim 14, wherein the sealing agent is applied in a rectangular frame form.

19. A method of dropping a liquid material which drops a liquid material onto one of two substrates, comprising:
a step of dropping the liquid material in the form of droplets in the area surrounded by applying a sealing agent onto one of the two substrates in the form of a frame having corner portions; and
a step of setting the droplets to be positioned at corner portions of an area to a size larger than the droplets to be positioned along the sealing agent.

20. The method of dropping a liquid material according to claim 19, wherein the droplets are dropped in the area with a predetermined arrangement pattern, the droplets are dropped in a peripheral portion deviating from the arrangement pattern in the area along the sealing agent at predetermined intervals, and a size of each droplet at each corner portion in the peripheral portion is set larger than a size of any other droplet in the peripheral portion.

21. The method of dropping a liquid material according to claim 19, wherein the droplets are dropped in the area with a predetermined arrangement pattern, and a size of each droplet dropped to each corner portion of the arrangement pattern is set larger than a size of any other droplet.

22. The method of dropping a liquid material according to claim 19, wherein the sealing agent is applied in a rectangular frame form.

23. An apparatus for dropping a liquid material, which drops a liquid material onto one of two substrates, comprising:
a dropping nozzle which drops the liquid material in the form of droplets in an area surrounded by applying a sealing agent onto one of the two substrates in the form of a frame having corner portions; driving means for relatively driving the dropping nozzle and the substrate on which the droplets are dropped in the horizontal direction; and
a control device which drops the droplets with a predetermined arrangement pattern in the area by controlling the driving by the driving means and dropping of the droplets from the dropping nozzle, and drops the droplets only to corner portions in a peripheral portion deviating from the predetermined arrangement pattern of the area.

24. The apparatus for dropping a liquid material according to claim 23, wherein the sealing agent is applied in a rectangular frame form.

25. An apparatus for dropping a liquid material, which drops a liquid material onto one of two substrates, comprising:
a dropping nozzle which drops the liquid material in the form of droplets in an area surrounded by applying a sealing agent onto one of the two substrates in the form of a frame having corner portions; driving means for relatively driving the dropping nozzle and the substrate on which the droplets are dropped in the horizontal direction; and
a control device which controls the driving means and the dropping nozzle which drops, thereby to drop the droplets from the nozzle to an area surrounded by the sealing agent, after setting the droplets to be positioned at corner portions of the area to a size larger than the droplets to be positioned along the sealing agent.

26. The apparatus for dropping a liquid material according to claim 25, wherein the sealing agent is applied in a rectangular frame form.
